(19) United States
(12) Patent Application Publication
(10) Pub. No.: US 2018/0065435 A1
(43) Pub. Date: Mar. 8, 2018

(54) FLYING CAR

(71) Applicant: AKASH GIRENDRA BAROT, SAN JOSE, CA (US)

(72) Inventor: AKASH GIRENDRA BAROT, SAN JOSE, CA (US)

(21) Appl. No.: 15/256,552

(22) Filed: Sep. 3, 2016

(51) Int. Cl. B60F 5/02; B64C 37/00; B64C 27/08; B64C 27/14

(52) U.S. Cl. CPC B60F 5/02; B64C 27/14; B64C 27/08; B64C 37/00

(57) ABSTRACT

A safe, easy to control, efficient, and compact flying car configuration is enabled through the combination of multiple vertical lift rotors, and a thrust propellers which is placed on the center of lower frame of the vehicle. The vertical lift rotors, permits a balancing of the center of lift with the center of gravity for both vertical and horizontal flight whereas the propeller help to steer the vehicle in air. This multiple rotor system has the ability to tolerate a relatively large variation of the payload weight for hover, transition, or cruise flight while also providing vertical thrust redundancy. The passengers are safe inside the vehicle as the rotors and the propeller are surrounded by a thick frame around them. This rotors provide a controlled thrust for a specific lift range.

### BACKGROUND

### 1. Field of the Invention

This disclosure relates generally to a personal flying car configured to provide safe operations while achieving robust control. In particular, the flying car is a personal vehicle with vertical takeoff and landing capability, and that provides vertical and horizontal thrust in a controlled fashion for hover, transition and cruise flight. This vehicle is made to hover and in transit vertically within a specific altitude range.

### 2. Description of Related Art

A flying car is personal aircraft that provides door-to-door aerial transportation (e.g., from home to work or to the supermarket) as conveniently as a car.

Taking off and landing vertically till it gets adequate lift, requires a flying car to provide vertical thrust. Thrust produced in the vertical direction provides lift to the vehicle and is able to control these forces in a balanced fashion.

The quadcopter, is one common type of VTOL. Quadcopter have medium size rotors that provide both vertical and horizontal thrust. For the rotors to perform this dual function across a range of airspeeds, the rotors are typically quite complex. Depending on the vehicle flight condition, the rotor blades must be at different orientation angles around the 360 degrees of azimuth rotation to provide the needed thrust. Collective varies the angle of each blade equally, independent of the 360-degree rotation azimuth angle. Cyclic varies the blade angle of attack as a function of the 360-degree rotation azimuth angle. Cyclic control allows the rotor to be tilted in various directions and therefore direct the thrust of the rotor forwards, backwards, left or right. This direction provides control forces to move the quadcopter in the horizontal plane and respond to disturbances such as wind gusts.

Quadcopter rotors are medium sized compared to rotors of helicopter. Additionally, they utilize mechanically complex systems to control both the collective and cyclic blade angles. Such rotors are mechanically complex and require maintenance.

### SUMMARY

The personal flying car with a configuration that is safe, quiet, and efficient, as well as easy to control, highly compact, more like a modern days car and able to accomplish vertical takeoff and landing with transition of moving in any direction. In one embodiment, the flying car configuration includes multiple rotors oriented to provide vertical thrust for lift and control during takeoff, transition to and from forward, backward, left and right flight and landing. The rotors are attached to the quad-frame in fixed, non-planar orientations. The orientations of rotors provide lateral, fore and aft control of flying car without requiring a change of attitude, and minimize disturbances to the flow when the flying car is cruising. The rotors have forward, backwards, left, and right orientations, and are located on the corners of the flying car with one or more rotors located on each side.

The flying car has a place for 2 or more seats in the vehicle. The rotors provide lift and control during cruise, and one propeller provide forward, backward, left, right thrust. The combination of vertical lift bound the rotors, permitting movement in the flying car's center of gravity while still enabling the vehicle to maintain vertical flight control. The forward and rear rotors are also located to provide a boundary to avoid foreign object damage (FOD) to the lift rotors. The vertical lift rotors are arranged around the center of gravity, and the thrust of each rotor is adjustable, which permits the relocation of the center of lift in vertical flight if the center of gravity shifts.

Due to the multiple number and independence of the vertical lift rotors, the vertical thrust is redundant and thrust and control remain available even with the failure of any single rotor. Since there are multiple vertical rotors that provide large control forces, the rotors are smaller, with faster response rates for operation even in gusty wind conditions. Low tip speed vertical lilt rotors are used to produce low community noise levels during takeoff, transition, and landing. Since the lift rotors that are used for vertical lift are separate from the thrust propellers which is on the bottom of the flying car, each is optimized for its specific operating conditions. Such a vehicle can be used for either piloted or unpiloted across a range of occupant sizes or payloads.

### BRIEF DESCRIPTION OF THE DRAWINGS

FIG. 1 is a top view of a personal flying car vehicle in accordance with one embodiment.

FIG. 2 illustrates a view of the left side of a personal flying car vehicle in accordance with one embodiment.

FIG. 3 is a block diagram illustrating a steering and propeller controller in accordance with one embodiment.

### DETAILED DESCRIPTION

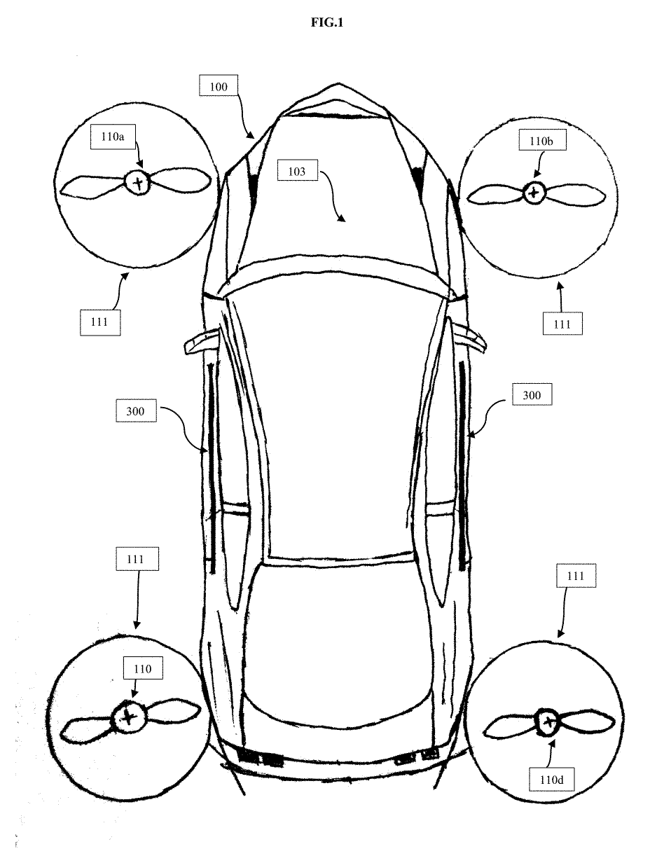

FIG. 1 illustrates a flying car 100 in accordance with one embodiment. Flying car 100 includes vertical lift rotor assemblies 110 a and 110 b and 110 c and 110 d (generally, 110) with fixed orientations; rotor fence 111; flight propellers 120 (not shown), a main body of the vehicle 103, a detachable battery 300 power source which is located inside the main body 103. Main body 103 also includes Tires (not shown), a computer to control inter mechanism of the vehicle (not shown), each of which is described further below.

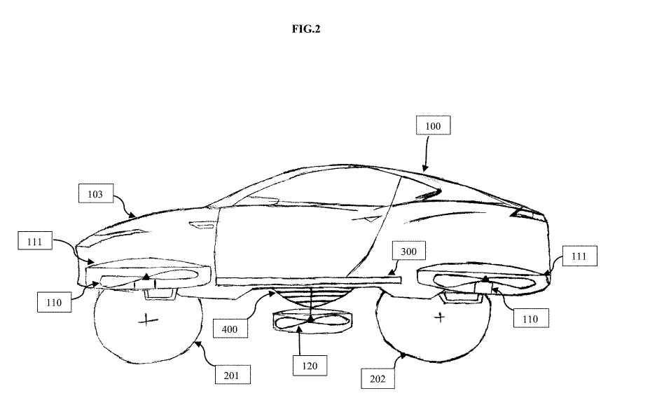

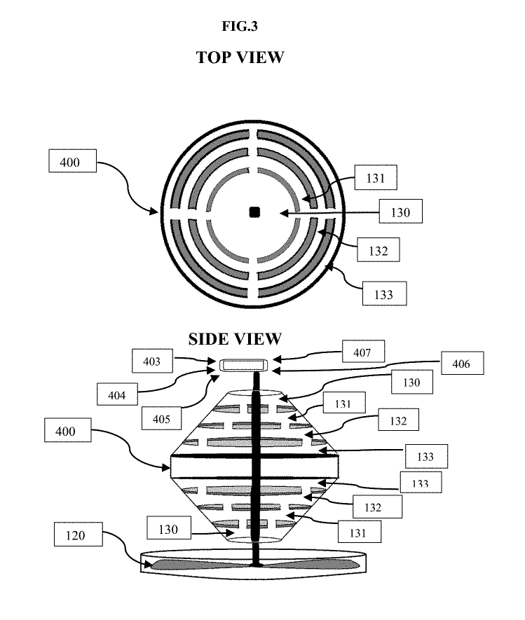

FIG. 2 illustrates a side view of flying car 100, including propeller 120; controller 400; detachable battery 300 power source; vertical lift rotor assemblies 110 and rotor fence 111; front tires 201 and rear tires 202. FIG. 3 illustrates a side view and a top view of the controller 400 whose one part will be inside the main body and the other part will be attached to the propeller 120.

In various embodiments, flying car 100 is sized to accommodate more than one passenger and personal cargo. The passenger itself can be a vehicle driver.

Flying car 100 is constructed in various embodiments primarily of a composite material. Main body 103 is made from carbon fiber composite material. In some embodiments the rotors fence 111 skins may comprise composite materials made of carbon fiber combined with other composite materials such as Kevlar. The composite main body skin in this embodiment may be made of carbon fiber, Kevlar, or other composite materials as understood by those of skill in the art. The windows in one embodiment are polycarbonate, though other lightweight clear plastics may also be used.

Rotor assemblies 110 include rotors that in one embodiment have a 20 inch radius, and are made from carbon fiber composite material, and in an alternative embodiment from carbon fiber composite blades attached to an aluminum hub. In other embodiments, rotors are made from wood blades attached to an aluminum hub, or wood blades attached to a carbon fiber composite hub. The rotors may be a single piece that bolts onto the motor assembly. Rotor assemblies 110 are described further below.

Flying car 100 includes front two or more rotors and rear two or more rotors 110. To maintain minimal length and width and have the center of gravity in the center of the rotor system, the front and rear rotors are similar in span. The rotors provide lateral stability. This rotors provide a lift to the flying car. Vertical lift rotor assemblies 110 are mounted on each corner of the flying car 100 as shown in FIG. 1. In this embodiment, propellers 120 are attached to center bottom of the main body 103, and the vertical lift rotor assemblies 110 are installed on four corners of the main body 103. This rotors 110 are attached to the main body 103 with struts 116. The struts 116 are positioned so that the downwash from the rotors does not impinge on the struts. In some embodiments there are four struts connecting each to the main body. In alternative embodiments there are two struts connecting each to the main body. In other embodiments the struts may be swept forward, aft, up, or down to improve the attachment with the main body. For example, a vertically oriented support structure provides increased bending stiffness from the vertical lift rotor loads during hover.

Each vertical lift rotor assembly 110 includes a rotor and a motor. The rotor may comprise blades attached to a hub, or may be manufactured as a single piece with an integral hub. The hub provides a central structure to which the blades connect, and in some embodiments is made in a shape that envelops the motor. The motor includes a rotating part and a stationary part. The rotating part is concentric to the stationary part, known as a radial flux motor. The stationary part may form the outer ring of the motor, known as an inrunner motor, or the stationary part may form the inner ring of the motor, known as an outrunner motor. The rotating and stationary parts are flat and arranged in opposition to each other, known as an axial flux motor. In some embodiments the motor parts are low-profile so that the entire motor fits within the hub of the rotor, presenting lower resistance to the air flow when flying forward. The rotor is attached to the rotating part of the motor. In some embodiments the motor is a permanent magnet motor and is controlled by an electronic motor controller. The electronic motor controller sends electrical currents to the motor in a precise sequence to allow the rotor to turn at a desired speed or with a desired torque.

As noted, flying car 100 includes multiple rotor assemblies 110 per side. The vertical lift rotors provide enough thrust to lift the flying car 100 off the ground and maintain control. In one embodiment, each rotor generates more, e.g., 40% more, thrust than is needed to hover, to maintain control in all portions of the flight envelope. The rotors are optimized by selecting the diameter, blade chord, and blade incidence distributions to provide the needed thrust with minimum consumed power at hover and low speed flight conditions. In various embodiments, front left and rear left of the rotors rotate in one direction, and the front right and rear right rotate in the opposite direction to balance the reaction torque on the flying car. In some embodiments, the rotors may be individually tuned to account for different interactions between the rotors, or between the airframe and the rotors. In such embodiments the tuning includes adjusting the incidence or chord distributions on the blades to account for favorable or adverse interactions and achieve the necessary performance from the rotor. In the embodiment illustrated in FIG. 1, four vertical lift rotor assemblies 110 per side are shown. In alternative embodiments more or fewer vertical lift rotors provide the vertical lift and control. When at least two rotors per side arr present, the ability to produce a vertical force with equilibrium about the center of gravity is retained.

In one embodiment, two vertical lift rotor assemblies 110 per side are located in front and two are located in the behind. In this manner, the center of lift of the rotors in hover is co-located with the center of gravity of the flying car. This arrangement permits a variation of longitudinal or lateral positioning of the payload in the main body 103. Flight computer which is placed inside the main body of the flying car 100 modifies the thrust produced by each vertical lift rotor independently, providing a balanced vertical lift or, alternatively, unbalanced lift to provide control.

In some embodiments, the rotor orientation provides lateral and longitudinal control of the flying car 100 without requiring a change of attitude. Because rotor assemblies 110 are each mounted to cant outward, inward, forward, or back, a proper combination of rotor thrusts results in a net force in the horizontal plane, as well as the needed vertical lift force. This is helpful when maneuvering near the ground, for example. The orientations are also chosen to minimize disturbances to the flow when the flying car 100 is cruising. In some embodiments, the orientation of the rotors is varied forward, backward, left, and right, enabling the flying car 100 to maneuver in any direction without changing attitude. In other embodiments, the orientation is varied only left and right, minimizing the disturbance to the flow during cruise. In one embodiment with four rotors per side, the rotors are oriented, from front to back, 10 degrees out, 10 degrees in, 10 degrees in, and 10 degrees out.

Underneath propellers 120 provide the downwash thrust for transition to forward, backward, left and right flight, climb, descent, and cruise. In one embodiment thrust propellers 120 are mounted along the main body which is connected to the controller which helps the vehicle to steer. Use of a single propeller on the main body permits fewer components and less weight. The chord and incidence distributions are optimized to provide adequate thrust for acceleration and climbing both when the vehicle is moving slowly and supported in the air by the thrust of the rotors and when the flying car 100 is moving quickly and is fully supported by the lift of the rotors. Additionally, the chord and incidence distributions are selected to provide efficient thrust at the cruising speed of the flying car. In other embodiments the propellers utilize a variable pitch mechanism which allows the incidence of each blade to be adjusted depending on the flight condition.

The vertical lift rotors and the forward propellers are driven by electric motors that are powered by a power system. In one embodiment the power system includes a battery that is attached to one motor controller for each motor. In one embodiment the battery comprises one or more modules located within the main body of the flying car. In other embodiments the battery modules are located in the main body. The battery provides a DC voltage and current that the motor controllers turn into the AC signals that make the motors spin. In some embodiments the battery comprises lithium polymer cells connected together in parallel and in series to generate the needed voltage and current. Alternatively, cells of other chemistry may be used. In one embodiment the cells are connected into 120 cell series strings, and 6 of these strings are connected in parallel. In other embodiments, the cells are connected with more or fewer cells in series and more or fewer cells in parallel. In alternative embodiments, the rotors and propellers are powered by a power system that includes a hybrid-electric system with a small hydrocarbon-based fuel engine and a smaller battery. The hydrocarbon engine provides extended range in forward flight and can recharge the battery system.

The vertical lift rotor assemblies 110 in various embodiments are protected by protective fences 111 to avoid accidental blade strikes. In some embodiments the protective fence is designed to maximize the thrust of all the rotors near the fence by providing incremental lift. In this embodiment the fence 111 is shaped so that the flow over the fence induced by the rotor system 110 creates an upward force on the fence 111. This is accomplished by selecting a cross sectional shape and angle with respect to vertical of the fence that generates the upward force. In some embodiments the fence is designed to reduce the apparent noise of the rotor system by shielding bystanders from the noise of the rotors. In these embodiments, the fences are either filled with a conventional sound absorbing material, or are coated with a conventional sounds adsorbing material.

As noted, the use of multiple independently controlled rotors provides a redundant lift system. For example, a system that includes four or more rotors permits hover and vertical ascent/descent with safe operation without forward/backward airspeed.

FIG. 3 is a block diagram of a controller 400 in accordance with one embodiment. Controller 400 is located inside the flying car, typically within the main body 103. Controller 400 includes a rotor control module 403, propeller control module 404, position sensor interface 405, and a database 406. Position sensor interface 405 is communicatively coupled to the flying car's instruments and receives sensor data in one embodiment that includes the flying car's position, altitude, attitude and velocity. Rotor control module 402 receives data from position sensor interface 405 and from control inputs in the main body and determines how much thrust is required from each of the vertical lift rotors 110 to achieve the commanded response. Rotor control module 403 commands each rotor assembly 110 independently to produce the determined required thrust. Propeller control module 404 receives data from position sensor interface 405 and from control inputs in the main body, determines how much forward/backward/left/right thrust is required for the propellers 120, and commands the propellers to produce the required thrust. Database 406 includes programmed trajectories for ascent and descent to be used during transition, and may also include additional features used for navigation and control of flying car 100 as will be appreciated by those of skill in the art. Controller 400 also includes other components and modules to perform navigation and flight operations and which are known to those of skill in the art.

FIG. 2 illustrates a method for transitioning from vertical to forward flight in accordance with one embodiment. To begin, rotor control module 403 of controller 400 applies power to the rotors. In one embodiment, equal power is applied to each of the rotors during this initial phase of takeoff. In alternative embodiments different power is applied to each rotor during the initial phase of takeoff to facilitate taking off from a slope, or in a crosswind. Position sensor interface 405 receives attitude and altitude data from flying car 100 instruments. Once a minimum altitude, e.g., 2 feet above ground level, has been reached, propeller control module 404 activates the propellers 120 and in some embodiments activates their control input inside the main body control area. This helps the flying car 100 to hover. The flying car 100 stabilizes itself when it is in hover motion. As hover motion creates ground hover effect the position sensor helps the vehicle to stabilize and maintain center of gravity. The controller 400 as shown in FIG. 3 when in neutral mode allows the vehicle to hover. The vehicle hovers in neutral mode 130, with the help of propeller 120 it can hover forward/backward/left/right at a minimal speed and the rotor assemblies 110 gets the vehicle in hover motion. The rotor blades are at low angle in the neutral mode 130. In an alternative embodiment, a minimum of 2 feet to 3 feet of the ground altitude is required for powered forward propulsion. In other embodiments, the minimum altitude is adjustable and/or over-rideable. For example, driving in a school district may require flying car 100 to maintain altitude between 2 feet to 3 feet above the ground. The rotor assemblies 110 maintains the altitude by a controlled downwash, when gear 1 131 is set in the controller 400 it activates the propeller 120 to move forward/backward/left/right. When gear 1 131 is used the rotor blades remain unchanged at low angle very much like the angle used in neutral mode 130 to hover the flying car 100. Driving in city may require flying car 100 to maintain altitude between 3 feet to 5 feet above the ground and use the gear 2 132 in the controller to move forward/backward/left/right in the same fashion as used in gear 1 131. When gear 2 132 in controller 400 is used the rotor blades move to high angle to allow more force for downwash. Driving on a highway may require flying car 100 to maintain altitude between 5 feet to 8 feet above the ground and use the gear 3 133 in the controller to move forward/backward/left/right. When gear 3 133 in controller 400 is used the rotor blades move to higher angle giving the flying car 100 desired lift and forward propulsion in the same fashion as gear 1 131 and gear 2 132. A detachable battery 300 power source is fitted inside the main body frame of the vehicle allowing smooth functioning for replacing the battery.

In some embodiments, the driver programs an initial altitude into driving computer 407. Alternatively, the driver uses controller input to indicate that a higher altitude is desired. If additional altitude is required, position sensor interface 403 determines the flying car's attitude and velocity and rotor control module 403 adjusts power to the rotors individually as needed to maintain vertical thrust and a level orientation.

To transition the flying car 100 from forward to vertical flight, propeller control module 404 reduces the thrust of the forward propellers 120 to reduce speed. As the speed of the flying car 100 is reduced, rotor control module 403 automatically commands the rotors on generating more thrust for a vertical lift. The thrust required of the vertical lift rotors increases as the rotor blades change their angle from low, high, higher. The thrust from the rotors is adjusted by rotor control module 403 in response to readings from position sensor interface 405 to maintain during the transition an optimal trajectory determined by the flight computer, e.g., based on a trajectory stored in database 406, and reject any disturbances due to interactions or environmental effects such as gusts. Eventually the forward speed is zero or approaching zero and the vertical lift rotors provide all the lift. The vehicle then descends to the ground either via a descent command from the driver automatically reducing power to the individual rotors to maintain a desired descent rate and a level orientation.

In an embodiment including a rotor, the main body includes a two main front wheel 201 with two main rear wheels 202. The wheels permit the flying car 100 to move while on the ground. Two forward 201 and two rear 202 Wheels provide lower drag and less lift interference. In some embodiments, all of the four wheels are fitted with electric motors that allow the wheels to be driven. Such motors allow the vehicle to be self-propelled while on the ground.

In addition to the embodiments specifically described above, those of skill in the art will appreciate that the invention may additionally be practiced in other embodiments. For example, in an alternative embodiment, flying car 100 is designed to accommodate two or more occupants. In such an embodiment, the rotors have a larger diameter, and the main body 103 is wider. In an alternative embodiment, flying car 100 is an unmanned vehicle that is capable of driving without a driver or passengers. Embodiments without passengers have additional control systems that provide directional control inputs in place of a driver, either through a ground link or through a predetermined flight path trajectory.

Although this description has been provided in the context of specific embodiments, those of skill in the art will appreciate that many alternative embodiments may be inferred from the teaching provided. Furthermore, within this written description, the particular naming of the components, capitalization of terms, the attributes, data structures, or any other structural or programming aspect is not mandatory or significant unless otherwise noted, and the mechanisms that implement the described invention or its features may have different names, formats, or protocols. Further, some aspects of the system including components of the controller 400 may be implemented via a combination of hardware and software or entirely in hardware elements. Also, the particular division of functionality between the various systems components described here is not mandatory; functions performed by a single module or system component may instead be performed by multiple components, and functions performed by multiple components may instead be performed by a single component. Likewise, the order in which method steps are performed is not mandatory unless otherwise noted or logically required.

Unless otherwise indicated, discussions utilizing terms such as “selecting” or “computing” or “determining” or the like refer to the action and processes of a computer system, or similar electronic computing device, that manipulates and transforms data represented as physical (electronic) quantities within the computer system memories or registers or other such information storage, transmission or display devices.

Electronic components of the described embodiments may be specially constructed for the required purposes, or may comprise one or more general-purpose computers selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

1. A flying car comprising:
a main body;
a X frame attached to the main body
a plurality of lift rotors mounted on the X frame wherein each rotor produces an amount of vertical thrust independent of levels of vertical thrust produced by the other rotors;
a propeller coupled to the main body frame and adapted to provide forward/backward/left/right thrust.
a detachable battery placed within the main body frame

2. The flying car of claim 1 further comprising:

3. The flying car of claim 1 wherein the lift rotors are driven by electric motors.

4. The flying car of claim 1 wherein the propeller is coupled to the lower center bottom of the main body frame and driven by an electric motor.

5. The flying car of claim 1 wherein the propeller is connected to the controller which is inside the main body of the flying car.

6. The method of claim 5 further comprising:
Controller having a neutral gear/hover gear, gear 1, gear 2, gear 3.
Controller controlling the speed of the rotors and angle of the rotor blades.
Controller using data received from the database to maintain flying car stabilization.

7. The flying car of claim 1 wherein the detachable battery power source is placed inside the detachable battery case in the lower frame of the main body.

8. The flying car of claim 1 further comprising:

9. A method for flying a VTOL flying car, the method comprising:
Providing the flying car of claim 1;
Producing using the plurality of rotors a vertical thrust to cause the flying car to ascend;
Producing forward/backward/left/right thrust to the flying car using the propeller.
Transitioning the flying car within a specific range for hover, gear 1, gear 2 and gear 3.

10. The method of claim 6 further comprising:
Transitioning the flying car from vertical to forward motion by reducing the vertical thrust produced by the rotors while increasing the forward thrust produced by the propeller.

11. A method of controlling the controller for a VTOL flying car, the method comprising:
Providing the flying car of claim 1;
Neutral mode produces enough thrust to lift the flying car and hover at 2 feet to 3 feet above ground;
Neutral mode allows the flying car to hover and move at minimal speed;
Rotor blades in neutral mode are at low angle.
Gear 1 of the controller gets the flying car to hover at 2 feet to 3 feet above ground;
The propeller gives the forward propulsion to the flying car;
Rotor blades in gear 1 are at low angle.
Gear 2 of the controller gets the flying car to hover at 3 feet to 5 feet above ground;
The propeller gives the forward propulsion to the flying car;
Rotor blades in gear 2 are at high angle.
Gear 3 of the controller gets the flying car to hover at 5 feet to 8 feet above ground;
The propeller gives the forward propulsion to the flying car;
Rotor blades in gear 3 are at higher angle.
